(19) United States
(12) Patent Application Publication
(10) Pub. No.: US 2026/0364712 A1
(43) Pub. Date: Nov. 19, 2026

(54) SYSTEM AND METHOD FOR SETTING CUTTING PARAMETER VALUES OF A LASER CUTTING MACHINE FOR SHEET METAL

(71) Applicant: TRUMPF Werkzeugmaschinen SE + Co. KG, Ditzingen (DE)

(72) Inventors: Philipp Leube, Stuttgart (DE); Aastha Aastha, Ludwigsburg (DE); Manuel Geiger, Möglingen (DE); Korbinian Weiss, Korntal (DE)

(21) Appl. No.: 19/577,453

(22) Filed: Mar. 25, 2026

Related U.S. Application Data
(63) Continuation of application No. PCT/EP2024/074691, filed on Sep. 4, 2024.

(30) Foreign Application Priority Data
Sep. 29, 2023 (DE) 10 2023 126 702.7

(51) Int. Cl. B23K 26/03; B23K 26/38; G06T 7/00

(52) U.S. Cl. CPC B23K 26/032; B23K 26/38; G06T 7/0004; G06T 2207/20021; G06T 2207/20081; G06T 2207/30108

(57) ABSTRACT

A method for setting values for cutting parameters of a laser cutting machine for sheet metal, the method including producing at least one first cut edge by the laser cutting machine using a plurality of first cutting parameter values, creating at least one first image of the produced cut edge, and automatically determining a plurality of second cutting parameter values based on the at least one first image. The plurality of second cutting parameter values includes the same cutting parameters as the plurality of first cutting parameter values. The plurality of second cutting parameter values has at least one cutting parameter value that differs from the plurality of first cutting parameter values. The method further includes setting the plurality of second cutting parameter values on the laser cutting machine.

### CROSS REFERENCE TO RELATED APPLICATIONS

This application is a continuation of International Application No. PCT/EP2024/074691 (WO 2025/067832 A1), filed on Sep. 4, 2024, and claims benefit to German Patent Application No. DE 10 2023 126 702.7, filed on Sep. 29, 2023. The aforementioned applications are hereby incorporated by reference herein.

### FIELD

The invention relates to a method for setting cutting parameter values of a laser cutting machine for sheet metal and to a system for setting cutting parameter values of a laser cutting machine for sheet metal.

### BACKGROUND

A method for setting cutting parameter values is known from WO 2022/058113 A1.

### SUMMARY

In an embodiment, the present disclosure provides a method for setting values for cutting parameters of a laser cutting machine for sheet metal, the method comprising producing at least one first cut edge by the laser cutting machine using a plurality of first cutting parameter values, creating at least one first image of the produced cut edge, and automatically determining a plurality of second cutting parameter values based on the at least one first image. The plurality of second cutting parameter values comprises the same cutting parameters as the plurality of first cutting parameter values. The plurality of second cutting parameter values has at least one cutting parameter value that differs from the plurality of first cutting parameter values. The method further comprises setting the plurality of second cutting parameter values on the laser cutting machine.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a system according to an embodiment according to the present disclosure;

FIG. 2 shows a training method according to an embodiment according to the present disclosure;

FIG. 3 shows a method according to an embodiment of the present disclosure;

FIG. 4 shows a training matrix;

FIG. 5 shows a further training matrix;

FIG. 6 shows an iterative setting of cutting parameter values; and

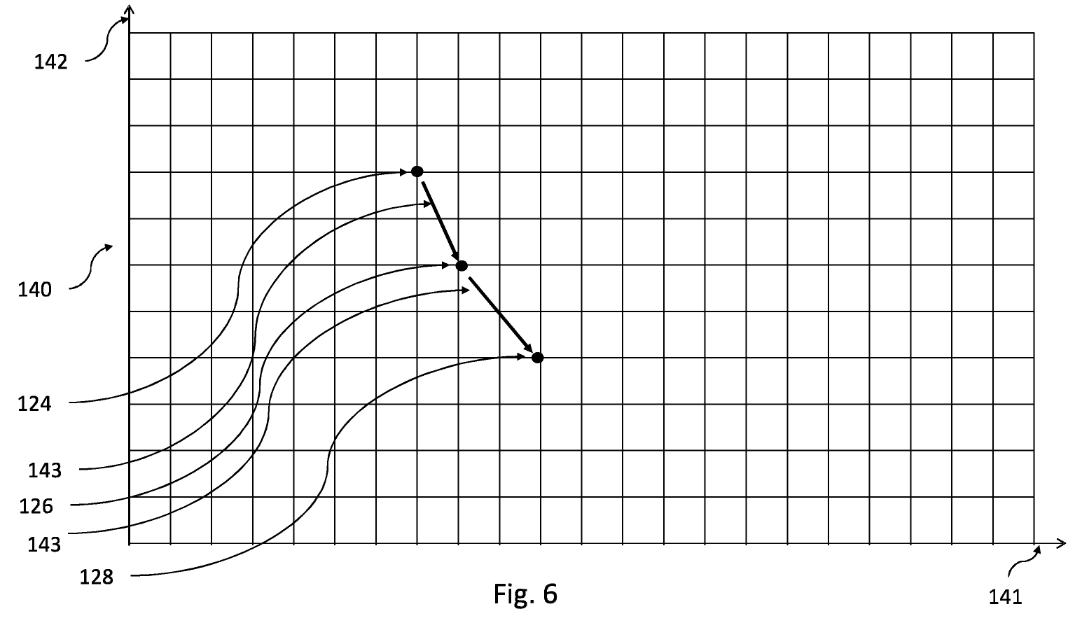

FIG. 7 shows a setting of cutting parameter values.

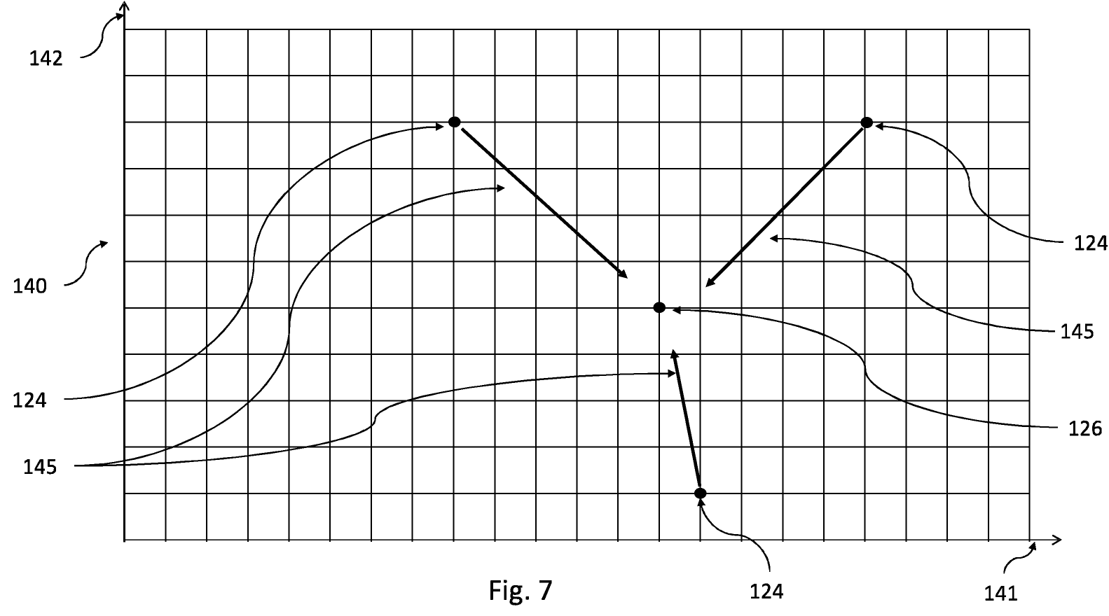

### DETAILED DESCRIPTION

In an embodiment, the present disclosure provides a system and a method as mentioned above which simplify the setting of cutting parameter values of a laser cutting machine for sheet metal.

Advantages according to the present disclosure are achieved with the aforementioned method in that with the laser cutting machine at least one first cut edge is produced by means of the laser cutting machine using a plurality of first cutting parameter values, wherein at least one first image of the produced cut edge is created, wherein a plurality of second cutting parameter values is determined automatically based on the first image, wherein the plurality of second cutting parameter values comprises the same cutting parameters as the plurality of first cutting parameter values, wherein the plurality of second cutting parameter values has at least one cutting parameter value that differs from the plurality of first cutting parameter values, wherein the plurality of second cutting parameter values is set on the laser cutting machine.

The method allows for a particularly simple adjustment of the cutting parameter values, as the cutting parameter values are readjusted based on an image of a cut edge. It is also irrelevant in this respect whether the plurality of first cutting parameter values is correctly implemented by the laser cutting machine, since the plurality of second cutting parameter values is determined on the image of the first cut edge and does not depend on the first cutting parameter values. Since each sheet metal piece is unique, cut edges can differ even with identical first cutting parameter values, and therefore different changes to the cutting parameter values can be desired even with identical cutting parameter values and nominally identical sheet metal.

It is understood that the method can be repeated with the second cutting parameter values to determine third cutting parameter values. In this way, the cutting parameter values can be optimized in an iterative manner.

In an embodiment, a direction and magnitude of a change in the plurality of first cutting parameter values are automatically determined based on the first image, wherein the change is applied to the plurality of first cutting parameter values and the plurality of second parameter values is determined in this manner. Therefore, it is not necessary to know the current cutting parameter values, as only a relative change in the cutting parameters is determined. This is particularly advantageous because the actual cutting parameter values can differ from the set cutting parameter values. This could be due to wear and tear or faulty calibration of the laser cutting machine. The direction and magnitude of the change can relate to several cutting parameters simultaneously. This can be understood as determining a change vector. The individual components of the vector are then applied to the corresponding cutting parameter values.

In an embodiment, the direction and magnitude of the change in the plurality of first cutting parameter values is determined by means of a trained artificial intelligence based on the first image. The trained artificial intelligence can be an artificial neural network, for example. The use of a trained artificial intelligence enables particularly fast and easy determination of the direction and magnitude of the change in the plurality of first cutting parameter values. How an artificial intelligence can be trained is explained below.

In an embodiment, the first image is divided into a plurality of smaller images and for each smaller image a proportional change in the plurality of first cutting parameter values is determined, wherein the direction and the magnitude of the change in the plurality of first cutting parameter values is determined from the proportional changes. By breaking down the images into smaller images, they can be analyzed more easily; this is particularly advantageous when using a trained artificial intelligence, as the AI model becomes simpler and, for example, requires less memory. Analyzing a plurality of smaller images improves the quality of determining the second cutting parameters compared to using a single smaller image.

In an embodiment, a plurality of first images is produced and for each first image a proportional change in the plurality of first cutting parameter values is determined, wherein the direction and magnitude of the change in the plurality of first cutting parameter values is determined from the proportional changes. By producing several first images and determining proportional changes, the determination of the second cutting parameters is further improved. It is understood that the majority of first images can also be broken down into a plurality of smaller images.

In an embodiment, a plurality of first cut edges is produced, each with a plurality of first cutting parameter values, wherein the multiple pluralities of first cutting parameter values are each different in pairs in at least one parameter value when producing the first cut edges, wherein at least one first image is created from each first cut edge, and wherein a plurality of second cutting parameter values is automatically produced based on the first images.

Each plurality of first cutting parameter values therefore differs from all other pluralities of first cutting parameters in at least one cutting parameter value. The cutting parameter, which has a different cutting parameter value, can be different in this regard. Thus, a first plurality of first cutting parameters can differ from a second plurality of first cutting parameters in the value for gas pressure, and can differ from a third plurality of first cutting parameters in the value for feed rate, and can differ from a fourth plurality of first cutting parameters in both the value for gas pressure and the value for feed rate.

An embodiment of the present disclosure comprises a method for training an artificial intelligence to set cutting parameter values of a laser cutting machine for sheet metal, wherein a plurality of cut edges with different cutting parameter values is produced, wherein at least one training image is created for each cut edge, wherein a quality parameter value is determined for at least one quality parameter for each cut edge, wherein the quality parameter value is determined by means of one or more sensors, wherein the quality parameter values of the plurality of cut edges are entered into a matrix based on the associated cutting parameter values, wherein a preferred direction and magnitude of a change in the cutting parameter values is determined for each entry of the matrix, wherein the artificial intelligence is trained to output the preferred direction and magnitude of the change in the cutting parameter values for each image which is assigned to an entry of the matrix, wherein the artificial intelligence after training is suitable to be used, in particular in a method described above, to determine the direction and magnitude of the change in the first cutting parameter values.

For training purposes, the plurality of training images is divided into reference images and test images. The reference images are used to adjust the parameters of the artificial intelligence. The test images are used to check the quality of the trained artificial intelligence. In a first training step, the artificial intelligence is presented with the reference images and the parameters of the artificial intelligence are algorithmically set such that for each reference image the associated preferred direction and magnitude of a change in the cutting parameter values is output. In a second training step, the test images are presented to the artificial intelligence, and the preferred direction and magnitude of a change in the cutting parameter values output by the artificial intelligence is compared with the preferred direction and magnitude of a change in the cutting parameter values belonging to the respective test image. This process is repeated until the preferred direction and magnitude of a change in the cutting parameter values output by the artificial intelligence essentially matches the preferred direction and magnitude of a change in the cutting parameter values belonging to the respective test image. If necessary, additional cut edges and images of the cut edges can be produced for further training data.

The cutting parameter values used for the plurality of cut edges are preferably different in pairs. A separate plurality of cutting parameter values is used for each cut edge. This results in more diverse images and the matrix becomes larger. The denser data space makes the method more robust and improves the training of the artificial intelligence.

In an embodiment, a gradient of the quality parameter value is determined for each entry of the matrix, wherein the preferred direction and magnitude of the change in the cutting parameter values is the gradient of the quality parameter value at the respective entry of the matrix. The gradient can be determined, for example, for each entry of the matrix from the differences to neighboring entries. Preferably, a mathematical function is determined for the gradient, with the values of the matrix serving as support points for the mathematical function. For each point of the matrix, the gradient of the mathematical function is assumed to be the gradient of the quality parameter value. The preferred direction of the change in the cutting parameter values therefore points in the direction of the greatest change in the quality parameter value. The preferred magnitude of the change depends on the magnitude of the change in the quality parameter value. The mathematical function can, in this regard, be any suitable function for approximating or interpolating the matrix values. Preferably, the mathematical function is a polynomial. This method trains a particularly preferred change in the cutting parameter values.

In an embodiment, an optimal value of the quality parameter value is determined from all entries of the matrix, wherein for each entry of the matrix a direction and a distance to the optimal value of the quality parameter value is determined, wherein the preferred direction and magnitude of the change in the cutting parameter values is the direction and the distance from the optimal value of the quality parameter value at the respective entry of the matrix. The optimal value can be the best quality parameter value of all entries of the matrix. Preferably, a mathematical function, in particular a polynomial, is determined for the optimal value, wherein the values of the matrix serve as support points for the mathematical function. In this case, the optimal value is an extreme value of the mathematical function. Depending on the quality parameter, the optimal value can be a minimum or a maximum of the mathematical function. The preferred direction of the change in the cutting parameter values therefore points from the entry of the matrix towards the best possible value for the quality parameter, which is interpolated by the mathematical function. The preferred magnitude of the change depends on the distance of the entry of the matrix from the best possible quality parameter value. This method trains an alternative, particularly expedient change to the cutting parameter values.

In an embodiment, values of a first cutting parameter and a second cutting parameter are varied, and all other cutting parameters have constant cutting parameter values, wherein the matrix has two dimensions, wherein the first cutting parameter is varied in a first dimension and the second cutting parameter is varied in the second dimension. By varying only two cutting parameters, a very simple two-dimensional matrix can be created. For this two-dimensional matrix, a mathematical function with two variables and an output value can very easily be adapted to the matrix values as an interpolation function, thus enabling one of the configurations described above.

It is understood that a plurality of two-dimensional matrices can be created, each with different, varied cutting parameters. A mathematical function can be adapted to each of these matrices. For each matrix, a separate artificial intelligence can be trained to output the preferred direction and magnitude of the change in the cutting parameter values. For example, one artificial intelligence can output the change in feed rate and distance between the gas nozzle and the sheet metal, and another artificial intelligence can output the change in the focal position of the cutting laser and the pressure of the cutting gas. The overall preferred direction and magnitude of the change in the cutting parameter values can then be calculated from the individual outputs of the artificial intelligences.

Alternatively, a multidimensional matrix with many varied cutting parameters can be created. The mathematical function for interpolation then requires a correspondingly large number of variables. The artificial intelligence is then trained to output the preferred direction and magnitude of the change in the cutting parameter values for a corresponding number of cutting parameters. The artificial intelligence preferably outputs a vector with a correspondingly large number of components.

In an embodiment, the training is performed for a specified process, wherein the process is specified by one or more values of the following process parameters: a sheet metal type, a sheet metal thickness, a process type, a used nozzle, a laser power. The sheet metal type is, for example, stainless steel, structural steel, aluminum, or copper. The sheet metal thickness is, for example, 1 mm, 2 mm, 3 mm, 5 mm, 10 mm, 15 mm, 20 mm, or a value therebetween. The process type is, for example, flame cutting with oxygen, cutting with nitrogen, or another laser cutting process. The laser power is, for example, 2 kW, 5 kW, 10 kW, 15 kW, 20 kW, or a value therebetween. Training on a specific process significantly improves the training result. When artificial intelligence is used, the artificial intelligence trained for the relevant process is used. The trained artificial intelligence can also be used for processes which do not exactly correspond to the trained process. In processes with differing process parameter values, similar quality characteristics lead to similar gradients or differences. Preferably, in processes with differing process parameter values, several trained artificial intelligences are used, and the direction and magnitude of the change determined by the trained artificial intelligences are offset against each other. For example, with a sheet metal thickness of 12 mm, the artificial intelligences trained for 10 mm and for 15 mm can be used.

Preferably, the quality parameter is one of the following: a burr on the produced cut edge, a discoloration on the produced cut edge, a roughness on the produced cut edge, a scaling on the cut edge, or a flipping melt on the cut edge. These quality parameters can be easily recognized in images, in particular by a trained artificial intelligence, and can be effectively influenced by adjusting the cutting parameters.

Preferably, the plurality of cutting parameters is selected from the following: a pressure of a cutting gas, a feed rate, a focal position of the cutting laser, a distance between the gas nozzle and the sheet metal. A laser cutting machine cuts sheet metal by directing a laser beam and cutting gas from a cutting head onto the sheet metal. The laser melts the sheet metal and the gas drives out the melt. In this context, the cutting head is moved along the contour to be cut across the sheet metal at the feed rate. The focal position of the cutting laser determines whether the laser focus is above the sheet metal, inside the sheet metal or below the sheet metal. The aforementioned cutting parameters each have a significant influence on at least one of the quality parameters mentioned above.

An embodiment of the present disclosure further relates to a method for setting cutting parameter values of a laser cutting machine with a trained artificial intelligence, wherein the trained artificial intelligence was trained according to any one of the methods described above.

An embodiment of the present disclosure further relates to a system for setting cutting parameter values of a laser cutting machine for sheet metal, comprising a laser cutting machine for sheet metal, a camera, and a computing unit, wherein the computing unit is provided and configured to carry out a method according to the present disclosure. It is understood that the computing unit can consist of or comprise several parts. For example, one computing unit can be provided and configured for training the artificial intelligence, one computing unit for controlling the laser cutting machine, and one computing unit for using the trained artificial intelligence.

Elements that are the same or have equivalent functions are denoted by the same reference signs in all the exemplary embodiments.

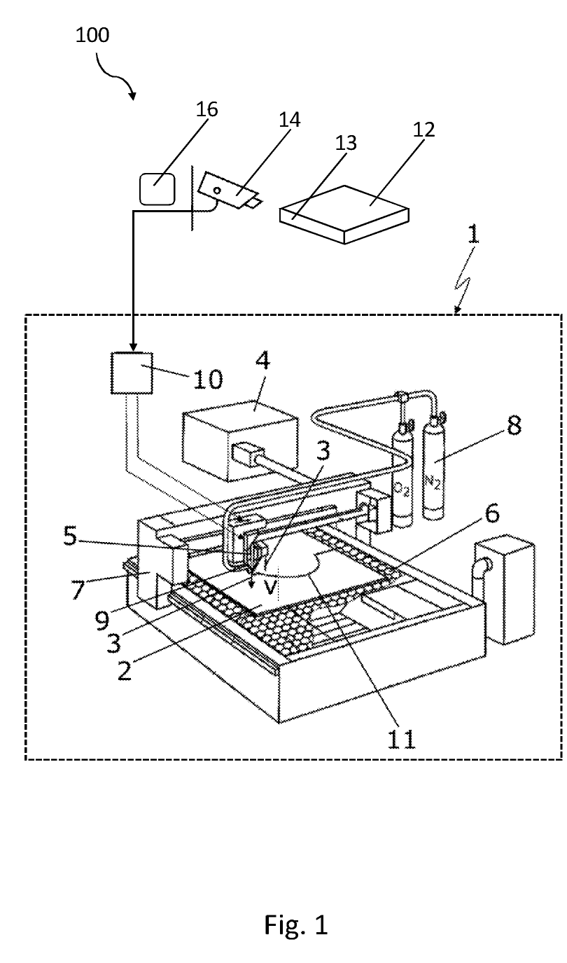

FIG. 1 shows a system 100 for setting cutting parameter values of a laser cutting machine 1 for sheet metal. In addition to the laser cutting machine 1 for sheet metal, the system 100 comprises a camera 14 and a computing unit 10.

The laser cutting machine 1 has a laser beam generator 4 for generating the laser beam 3, a laser cutting head 5, and a workpiece support 6 on which the sheet metal 2 is arranged. The laser beam 3, which is guided from the laser beam generator 4 to the laser cutting head 5 by means of an optical fiber or deflection mirrors, is produced in the laser beam generator 4. The laser beam 3 is directed onto the sheet metal 2 by means of a focusing optical unit arranged in the laser cutting head 5. The laser beam 3 exits the laser cutting head 5 in a z-direction and hits the workpiece 2 in the z-direction. The laser cutting head 5 can be moved above the sheet metal 2 in the x- and y-directions by means of a drive 7. The laser cutting machine 1 is moreover supplied with cutting gases 8, for example oxygen or nitrogen. The cutting gas 8 is supplied to a cutting nozzle 9 of the laser cutting head 5, from the nozzle opening of which said cutting gas exits conjointly with the laser beam 3.

The laser cutting machine 1 also comprises a computing unit 10 for controlling laser cutting parameters of the laser beam 3 and the cutting gas 8 and for controlling the drive 7 in order to move the laser cutting head 5 together with the emerging laser beam 3 according to a predetermined cutting contour 11 relative to the sheet metal 2 at a feed rate v.

Using the laser beam 3 and the cutting gas 8, the laser cutting machine 1 can cut out a sheet metal part 12 from the sheet metal 2. For cutting out, the cutting parameter values set on laser cutting machine 1 are used. The sheet metal part 12 is given a cut edge 13 by cutting it out along the cutting contour 11. Using the camera 14, an image 16 of the cut edge 13 can be created. The image 16 can be transmitted from the camera 14 to the computing unit 10. The computing unit 10 is designed and configured to automatically set the laser cutting parameter values on the laser cutting machine 1 based on the first image 16. The computing unit contains predefined algorithms for setting the laser cutting parameter values, e.g., a trained artificial intelligence.

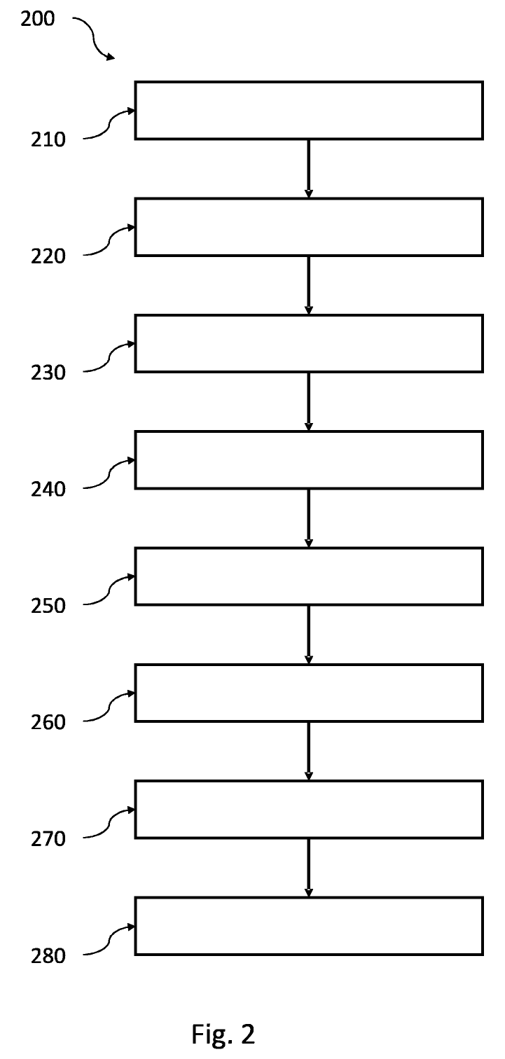

FIG. 2 shows a training method 200 for an artificial intelligence for setting cutting parameter values of a laser cutting machine 1 for sheet metal. The following describes the training of an artificial intelligence for setting cutting parameter values of a laser cutting machine 1 for sheet metal in connection with the system shown in FIG. 1.

In a first training step 210, a plurality of cut edges 13 with different cutting parameter values are produced using the laser cutting machine 1. The values of the process parameters, e.g., the sheet metal type, sheet metal thickness, process type, used nozzle and/or laser power remain unchanged here. The process parameter values define the process, and the artificial intelligence is trained for the process defined in this way. It goes without saying that an artificial intelligence can be trained in the same way for a differently defined process, i.e., a process with different process parameter values.

In a second training step 220, at least one image is produced from each cut edge 13 using the camera 14. For each image, at least one quality parameter value is determined and assigned to the image. The quality parameter value can be determined, for example, by the computing unit using an image processing algorithm. Alternatively, the quality parameter value can be determined directly at the respective cut edge using a suitable sensor. Alternatively, the quality parameter value can be determined by an operator. In an optional third training step 230, the images are broken down into smaller images. By breaking the images down into smaller images, the artificial intelligence model can be kept simpler and more training images can be produced very easily. In a fourth training step 240, the images are divided into reference images and test images. The preferred division is 70% to 30%; however, any other division is possible as long as there are enough images for both groups. It is particularly preferred that the images are divided in such a way that at least one reference image is obtained for each of the plurality of cutting parameter values used. This ensures that the matrix is filled particularly well in the next step.

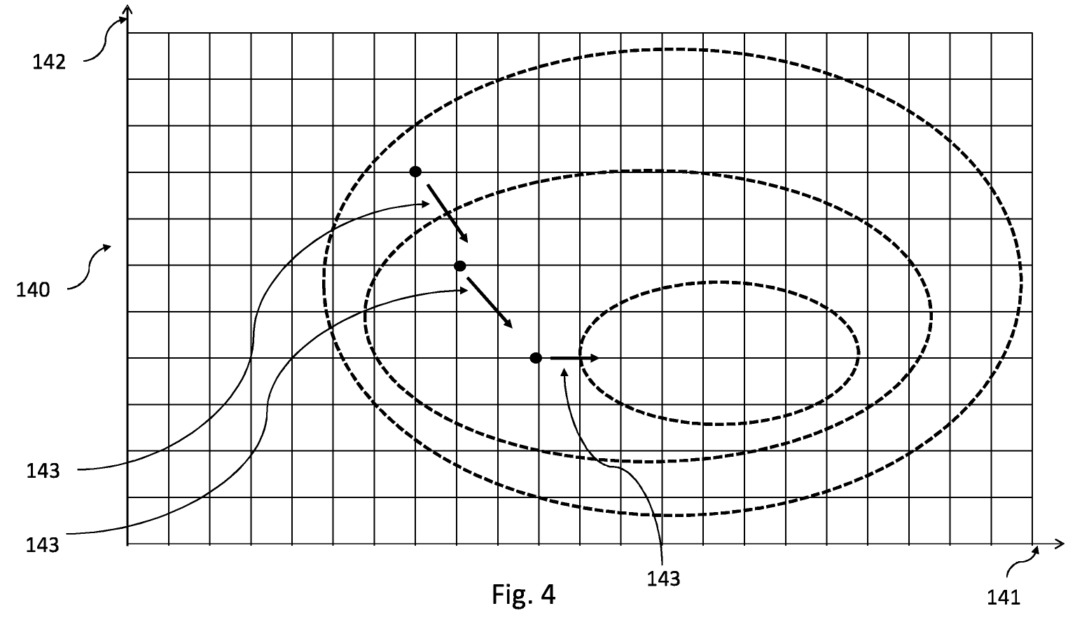

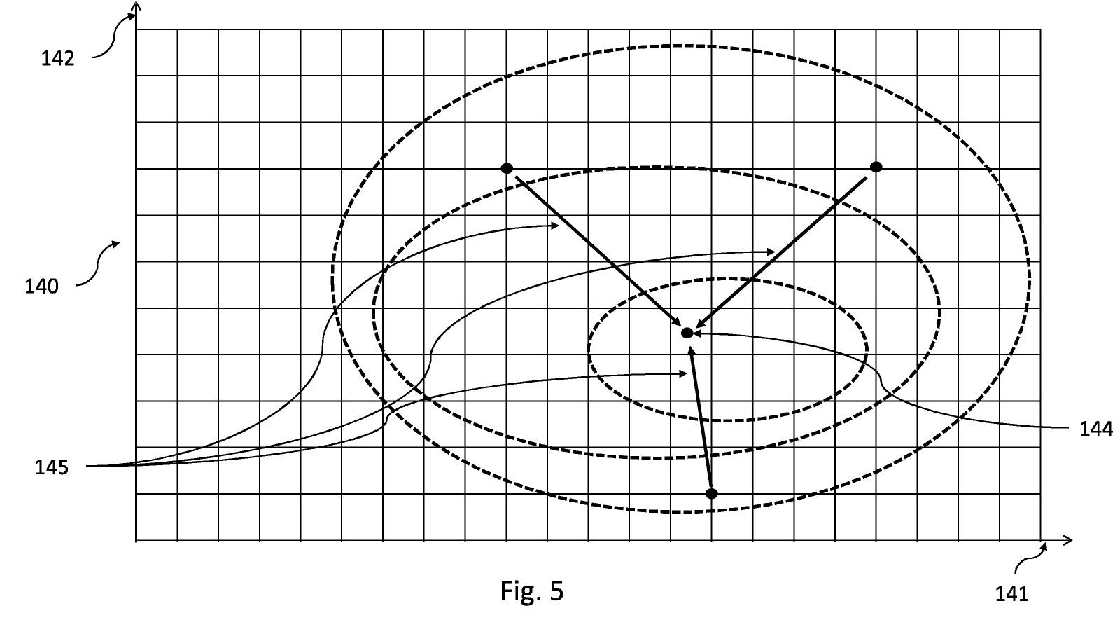

In a fifth training step 250, at least one matrix is created. In this context, the reference images are assigned to a position in the matrix according to the plurality of cutting parameter values used. Exemplary matrices 140 are shown in FIGS. 4 and 5. The gas pressure is plotted as a cutting parameter on the horizontal axis 141. The focal position is plotted as a cutting parameter on the vertical axis 142. The quality parameter is the roughness of the cut edge.

In a sixth training step 260, a mathematical function is determined based on the respective cutting parameter values of the reference images used and the associated quality parameter values. The mathematical function is determined such that its variables correspond to the cutting parameters on the axes of the matrix 140 and its output value corresponds to the quality parameter. When cutting parameter values from reference images are inserted into the mathematical function, the output value should correspond as closely as possible to the quality parameter value of the reference image. The mathematical function therefore interpolates the quality parameter values between the values of the matrix 140. In FIGS. 4 and 5, the dashed lines show pairs of cutting parameters with the same quality parameter values.

In a seventh training step 270, the preferred direction and magnitude of the change in the cutting parameters is determined for each reference image and test image. In the example from FIG. 4, the gradient 143 is determined for each point of the matrix 140 from the mathematical function and assigned to the reference image belonging to the point. For clarity, FIG. 4 shows three examples of points and gradients. Similarly, for the test images, the gradient 143 is determined at the corresponding positions of the matrix 140 using the mathematical function and the gradient 143 is assigned to the test images. In the example from FIG. 5, the optimal value 144 of the quality parameter is first determined, i.e., those cutting parameter values at which the quality parameter value assumes the best possible value. The optimal value of 144 can be the highest quality parameter value of all reference images. Preferably, and shown here, the optimal value 144 is determined from the mathematical function. The preferred direction and magnitude of the change in the cutting parameter values for each reference image is determined by the vector 145 from the point of the reference image in the matrix 140 to the optimal value 144. For clarity, FIG. 5 shows three examples of points and associated vectors for the optimal value. Each test image can also be assigned a point in the matrix and a corresponding vector 145 based on the cutting parameter values used in each case.

In an eighth training step 280, a model of an artificial intelligence, preferably a convolutional neural network (CNN), is trained. For this purpose, the reference images are used as input data and the model parameters are set such that the output corresponds to the preferred direction and magnitude of the change in the cutting parameters determined in the seventh training step. For each reference image, the artificial intelligence should output the corresponding vector. In order to verify whether the training of the model was successful, the test images are used as input data and the output of the artificial intelligence is compared with the preferred direction and magnitude of the change in the cutting parameters determined in the seventh training step.

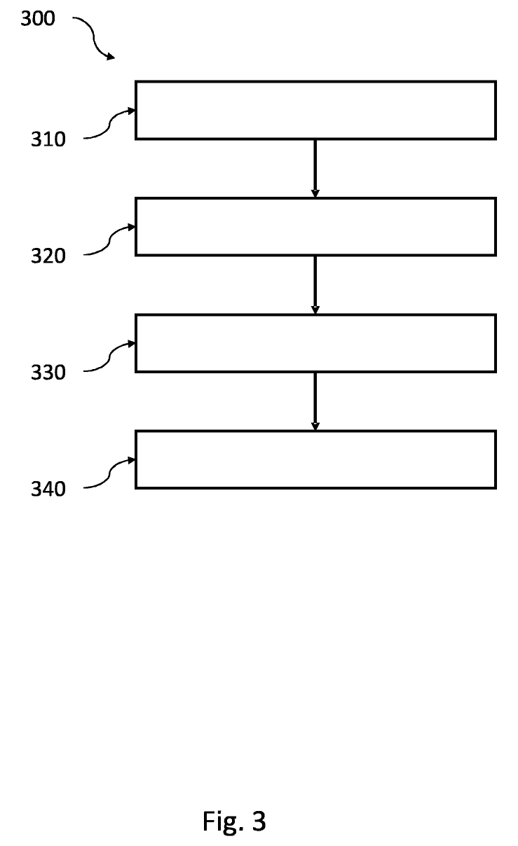

FIG. 3 shows a method 300 for setting values for cutting parameters of a laser cutting machine 1 for sheet metal. In a first application step 310, a cut edge 13 is produced. For this purpose, a sheet metal part 12 is cut out of the sheet metal 2 by the laser cutting machine 1. For cutting out, the first cutting parameter values 124 set on the laser cutting machine 1 are used. The sheet metal part 12 is given a cut edge 13 by being cut out.

In a second application step 320, a first image 16 of the cut edge 13 is created using the camera 14. The first image 16 is transmitted from the camera 14 to the computing unit 10. In an optional third application step 330, the first image 16 is broken down into a plurality of smaller images.

In a fourth application step 340, the computing unit 10 determines a plurality of second cutting parameter values 126 based on the first image 16. Preferably, a trained artificial intelligence is used for this purpose, the training of which has been described above. Based on the process parameters, an artificial intelligence trained for the corresponding process is selected. The first image 16, or the smaller images produced from the first image 16, are used as input data for the trained artificial intelligence. The trained artificial intelligence outputs, for each image as previously described, the preferred direction and magnitude of a change in the cutting parameter values. The preferred direction and magnitude of the change is applied to the plurality of first cutting parameter values 124 and the plurality of second cutting parameter values 126 is determined in this manner. The plurality of second cutting parameter values 126 is set on the laser cutting machine 1 and the method 300 is completed.

For better results, the method can be repeated starting with the plurality of second cutting parameter values. As indicated in FIG. 4, a preferred direction and magnitude of a change can be determined from a plurality of first cutting parameter values 124. After setting the second cutting parameter values, a new cut edge 13 is produced. A new image 16 is produced of the new cut edge 13, and a further preferred direction and magnitude of a change is determined based on the new image 16. By applying the further preferred direction and magnitude of a change to the second cutting parameter values 126, third cutting parameter values 128 are determined and the third cutting parameter values 128 are set on the laser cutting machine 1. In the iterative approach, it is advantageous to create one cut edge at a time and to determine the next preferred change based on an image, since each sheet metal is unique and identical changes to the cutting parameter values can have different effects on the cut edge even with nominally identical sheet metal.

Additionally or alternatively, for better results, several cut edges 13 can be produced, each with a different plurality of first cutting parameter values. For example, a sheet metal part 12 with several cut edges 13 can be cut out by the laser cutting machine 1, wherein a different plurality of first cutting parameter values 124 is used for each cut edge 13. As indicated in FIG. 5, a preferred direction and magnitude of a change can be determined from any plurality of first cutting parameter values 124. For each plurality of first cutting parameter values 124, the respective preferred direction and magnitude of a change is applied, and from the changed plurality of first cutting parameter values a plurality of second cutting parameter values is determined, e.g., by averaging. The plurality of second cutting parameter values is then set on the laser cutting machine.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 System
1 Laser cutting machine for sheet metal
2 Sheet metal
3 Laser beam
4 Laser beam generator
5 Cutting head
6 Workpiece support
7 Drive
8 Cutting gas
9 Cutting nozzle
10 Computing unit
11 Cutting contour
12 Sheet metal part
13 Cut edge
14 Camera
16 Image
120 Quality parameter
122 Cutting parameter
124 First cutting parameter values
126 Second cutting parameter values
128 Third cutting parameter values
140 Matrix
141 Gas pressure
142 Focal position
143 Gradient
144 Optimal value
145 Vector
200 Training method
210 First training step
220 Seciod training step
230 Third training step
240 Fourth training step
250 Fifth training step
260 Sixth training step
270 Seventh training step
300 Method for setting
310 First application step
320 Second application step
330 Third application step
340 Fourth application step

1. A method for setting values for cutting parameters of a laser cutting machine for sheet metal, the method comprising:
producing at least one first cut edge by the laser cutting machine using a plurality of first cutting parameter values;
creating at least one first image of the produced cut edge;
automatically determining a plurality of second cutting parameter values based on the at least one first image,
wherein the plurality of second cutting parameter values comprises the same cutting parameters as the plurality of first cutting parameter values,
wherein the plurality of second cutting parameter values has at least one cutting parameter value that differs from the plurality of first cutting parameter values; and
setting the plurality of second cutting parameter values on the laser cutting machine.

2. The method according to claim 1, comprising automatically determining a direction and a magnitude of a change in the plurality of first cutting parameter values based on the at least one first image; and
applying the change to the plurality of first cutting parameter values and thereby determining the plurality of second parameter values.

3. The method according to claim 2, wherein the direction and magnitude of the change in the plurality of first cutting parameter values is determined by a trained artificial intelligence based on the at least one first image.

4. The method according to claim 2, comprising dividing the at least one first image into a plurality of smaller images and for each of the plurality of smaller images determining a proportional change in the plurality of first cutting parameter values, wherein the direction and the magnitude of the change in the plurality of first cutting parameter values is determined from the proportional changes.

5. The method according to claim 2, wherein the at least one first image comprises a plurality of first images and for each of the plurality of first images a proportional change in the plurality of first cutting parameter values is determined, wherein the direction and the magnitude of the change in the plurality of first cutting parameter values is determined from the proportional changes.

6. The method according to claim 1, wherein the at least one first cut edge comprises a plurality of first cut edges each with a plurality of first cutting parameter values,
wherein the plurality of first cutting parameter values are each different in pairs in at least one parameter value when producing the plurality of first cut edges,
wherein at least one of the at least one first images is created from each of the plurality of first cut edges, and
wherein the plurality of second cutting parameter values is produced automatically based on the plurality of first images.

7. A method for training an artificial intelligence to set cutting parameter values of a laser cutting machine for sheet metal, the method comprising:
producing a plurality of cut edges, each with different cutting parameter values;
creating at least one training image from each of the plurality of cut edges;
determining for each of the plurality of cut edges a quality parameter value for at least one quality parameter;
determining the quality parameter values using one or more cameras;
entering the quality parameter values of the plurality of cut edges into a matrix based on associated cutting parameter values;
determining a preferred direction and magnitude of a change in the cutting parameter values for each entry of the matrix;
training the artificial intelligence to output, for each image which is assigned to an entry of the matrix, the preferred direction and magnitude of the change in the cutting parameter values,
wherein the artificial intelligence, after training, is configured in accordance with the method according to claim 1 to be used to determine a direction and magnitude of a change in cutting parameter values.

8. The method according to claim 7, comprising determining for each entry of the matrix a gradient of the quality parameter value,
wherein the preferred direction and magnitude of the change in the cutting parameter values is the gradient of the quality parameter value at the respective entry of the matrix.

9. The method according to claim 7, comprising determining an optimal value of the quality parameter value from all entries of the matrix;
determining for each entry of the matrix a direction and a distance from the optimal value of the quality parameter value,
wherein the preferred direction and magnitude of the change in the cutting parameter values is the direction and distance from the optimal value of the quality parameter value at the respective entry of the matrix.

10. The method according to claim 7, wherein the values of a first cutting parameter and a second cutting parameter are varied and all other cutting parameters have constant cutting parameter values,
wherein the matrix has two dimensions,
wherein in a first dimension of the two dimensions, the first cutting parameter is varied and in the second dimension of the two dimensions, the second cutting parameter is varied.

11. The method according to claim 7, wherein the training is carried out for a specified process, wherein the specified process is specified by one or more values of the following process parameters:
a sheet metal type,
a sheet metal thickness,
a process type,
a used gas nozzle, and/or
a laser power.

12. The method according to claim 7, wherein the at least one quality parameter is one of the following:
a burr on a respective cut edge of the plurality of cut edges,
a discoloration of the respective cut edge,
a roughness of the respective cut edge,
a scaling on the respective cut edge, and/or
a flipping melt on the respective cut edge.

13. The method according to claim 1, wherein the plurality of cutting parameters are selected from the following:
a pressure of a cutting gas,
a feed rate,
a focal position of a cutting laser, and/or
a gap between a gas nozzle and the sheet metal.

14. A method for setting values for cutting parameters of a laser cutting machine for sheet metal, the method comprising:
producing at least one first cut edge by the laser cutting machine using a plurality of first cutting parameter values;
creating at least one first image of the produced cut edge;
automatically determining a plurality of second cutting parameter values based on the at least one first image,
wherein the plurality of second cutting parameter values comprises the same cutting parameters as the plurality of first cutting parameter values,
wherein the plurality of second cutting parameter values has at least one cutting parameter value that differs from the plurality of first cutting parameter values;
setting the plurality of second cutting parameter values on the laser cutting machine;
automatically determining a direction and a magnitude of a change in the plurality of first cutting parameter values based on the at least one first image; and
applying the change to the plurality of first cutting parameter values and thereby determining the plurality of second parameter values,
wherein the direction and magnitude of the change in the plurality of first cutting parameter values is determined by a trained artificial intelligence based on the at least one first image, and
wherein the trained artificial intelligence is trained using the method according to claim 9.

15. A system for setting cutting parameter values of a laser cutting machine for sheet metal, comprising:
a laser cutting machine for sheet metal;
a camera; and
a computer configured to carry out the method according to claim 1.
